(19) United States
(12) Patent Application Publication
(10) Pub. No.: US 2026/0172446 A1
(43) Pub. Date: Jun. 18, 2026

(54) SYSTEMS AND METHODS FOR DYNAMIC NETWORK DEVICE MANAGEMENT AND SECURITY

(71) Applicant: IOTSECURE, LLC, Duluth, GA (US)

(72) Inventors: Daniel Kuykendall, La Mirada, CA (US); Sanket Patel, Suwanee, GA (US)

(21) Appl. No.: 19/355,869

(22) Filed: Oct. 10, 2025

Related U.S. Application Data
(60) Provisional application No. 63/706,571, filed on Oct. 11, 2024.

(51) Int. Cl. H04L 9/40

(52) U.S. Cl. CPC H04L 63/1441; H04L 63/0876; H04L 63/101; H04L 63/1425; H04L 63/1433; H04L 63/20

(57) ABSTRACT

A computer-implemented method for dynamically managing network devices comprises: deploying a network agent to passively monitor traffic; applying hardware fingerprinting—including MAC attributes, clock-skew estimation, and transmission-behavior signatures—to identify devices; creating and continuously updating dynamic per-device baselines; detecting anomalies as deviations from those baselines; and automatically enforcing network-layer protections by assigning affected devices to DHCP-based micro-segmented subnets and isolating devices that exhibit anomalous behavior. By linking passive observation with device-specific fingerprints and adaptive baselines, the method programmatically reconfigures segmentation in response to behavior, reducing lateral-movement risk without active scanning or manual intervention.

### CROSS-REFERENCE TO RELATED APPLICATION

This application claims priority to U.S. Provisional Patent Application No. 63/706,571, filed Oct. 11, 2024, which is incorporated by reference herein in its entirety for all purposes.

### TECHNICAL FIELD

The present disclosure relates generally to network security and management and, more specifically, some embodiments related generally to one or more of dynamic discovery, identification, profiling, and protection of managed network devices, unmanaged network devices, or both through segmentation techniques.

### BACKGROUND

Modern enterprise networks include a mix of managed endpoints (e.g., laptops, servers, mobile devices) and unmanaged/agentless IoT and OT devices (e.g., sensors, cameras, medical and industrial controllers). Unmanaged devices often run vendor-specific stacks, are administered via external cloud services, and typically do not support endpoint agents, complicating visibility, inventory, and control.

Conventional controls such as Network Access Control (NAC) and Endpoint Detection and Response (EDR) can be effective for managed endpoints that support agents or 802.1X posture checks. In many deployments, however, they provide limited continuous coverage for unmanaged IoT/OT devices, and networks are frequently organized with static segmentation (e.g., fixed VLANs/ACLs) and periodic scans/log review. These approaches do not adapt forwarding behavior in real time to per-device network behavior, which makes rapid containment and least-privilege enforcement difficult at scale.

Accordingly, there is a need in some environments for systems and methods that passively observe traffic, perform hardware/behavioral fingerprinting (e.g., MAC-layer characteristics, clock-skew and transmission-behavior features), learn dynamic per-device baselines, and programmatically update segmentation (e.g., DHCP-based micro-segmentation and/or SDN-mediated policy changes) to isolate anomalous devices in near real time while preserving normal operations.

### SUMMARY

A computer-implemented method for dynamically managing network devices includes deploying an agent within a network to monitor network traffic, the agent configured to collect data from one or more network devices, the network devices comprising managed and unmanaged devices. The method may include performing passive network monitoring to analyze network traffic without active scanning. The method also includes discovering the one or more network devices based on the data collected by the agent, the discovering including identifying both wired and wireless devices. The method includes identifying, by a processor, characteristics of the one or more network devices using hardware fingerprinting and advanced protocol analysis, the identifying comprising analyzing unique device attributes selected from the group consisting of: Media Access Control (MAC) addresses, clock skew, and variations in transmission behaviors. The method also includes creating dynamic baseline profiles for each of the one or more network devices, the profiles being continuously updated based on observed device behavior over time. The method includes detecting anomalies in device behavior by comparing current behavior to the dynamic baseline profiles. The method also includes applying network-layer protections to the one or more network devices, wherein the protections are dynamically adjusted based on the detected anomalies and include assigning devices to micro-segmented subnets using DHCP-based micro-segmentation. The method includes isolating one or more network devices in response to detecting anomalous behavior.

A system for dynamically managing network devices includes a processor and a memory. The memory stores instructions that, when executed by the processor, cause the system to deploy an agent within a network to monitor network traffic, the agent configured to collect data from one or more network devices, the network devices comprising managed and unmanaged devices. The instructions also cause the system to perform passive network monitoring to analyze network traffic without active scanning. The instructions also cause the system to discover the one or more network devices based on the data collected by the agent. Additionally, the instructions cause the system to identify, by analyzing unique device attributes selected from the group consisting of: MAC addresses, clock skew, and variations in transmission behaviors. The instructions also cause the system to create dynamic baseline profiles for each of the one or more network devices, the profiles being continuously updated based on observed device behavior. The instructions also cause the system to detect anomalies in device behavior by comparing current behavior to the dynamic baseline profiles. Additionally, the instructions also cause the system to apply network-layer protections to the one or more network devices, the protections including dynamically adjusting network segmentation policies in response to detected anomalies and isolating the devices in micro-segmented subnets.

A non-transitory computer-readable medium storing instructions that, when executed by a processor, cause a system to deploy an agent within a network to monitor network traffic, the agent configured to collect data from one or more network devices, the network devices comprising managed and unmanaged devices. The instructions also cause the system to perform passive network monitoring to analyze network traffic without active scanning. The instructions also cause the system to discover the one or more network devices based on the data collected by the agent. The instructions also cause the system to identify the one or more network devices by analyzing unique device attributes selected from the group consisting of: MAC addresses, clock skew, and variations in transmission behaviors. The instructions also cause the system to create dynamic baseline profiles for each of the one or more network devices, the profiles being continuously updated based on observed device behavior. The instructions also cause the system to detect anomalies in device behavior by comparing current behavior to the dynamic baseline profiles. The instructions also cause the system to apply network-layer protections to the one or more network devices, the protections including dynamically adjusting network segmentation policies in response to detected anomalies and isolating the devices in micro-segmented subnets.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIGS. 1A-1E illustrate an example diagram illustrating the process of comprehensive asset discovery, identification, and monitoring in accordance with the systems and methods described herein. Each figure highlights different steps in the system's process, from initial network integration to asset discovery and dynamic protection.

FIG. 2 illustrates an example device management dashboard interface, in accordance with certain embodiments of the disclosed systems and methods.

FIG. 3 illustrates an example method for dynamically managing network devices in a computer network environment.

FIG. 4 illustrates an example system for dynamically managing network devices in accordance with various embodiments.

FIG. 5 illustrates an example zero-trust enforcement loop in accordance with certain embodiments of the disclosed systems and methods.

FIG. 6 illustrates an example system architecture 600 for dynamically managing network devices in accordance with certain embodiments of the disclosed systems and methods.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Embodiments of the systems, methods, and devices described herein may have one or more of the following capabilities. For example, one embodiment of the systems, methods, and devices described herein may include

The present invention provides a comprehensive framework for improving network security through a multi-stage process that involves dynamic discovery, identification, profiling, and protection of network-connected devices. These devices may include managed endpoints, such as workstations, servers, and smartphones, as well as unmanaged devices, such as Internet of Things (IoT) devices, medical equipment, and network peripherals. The invention addresses the challenges of securing increasingly complex networks that incorporate a wide range of device types, many of which may lack proper security controls. The technical solutions provided include advanced segmentation techniques, real-time behavioral analysis, and machine learning-driven identification, which together ensure comprehensive visibility, control, and security of all devices.

### Discovery Stage

In one embodiment, the system initiates with a discovery stage, in which an agent is deployed within the network. This agent may take various forms, including a hardware appliance, virtual machine, software installation, container, or any other suitable deployment form that is compatible with the network environment. The agent operates by collecting data from various sources within the network and securely communicating with an intelligence system. The intelligence system may reside on a cloud platform or be hosted on-premises, either as a hardware appliance or a virtual instance, depending on the specific network architecture.

The discovery process may involve several data collection techniques to ensure comprehensive visibility into all network-connected devices. For example, the system may employ passive network monitoring. For example, in some embodiments Deep Packet Inspection (DPI) and/or flow analysis may be used to analyze packet contents without active scanning, thus minimizing any potential disruption to network performance. The system may also utilize flow analysis protocols, such as NetFlow or sFlow, to observe traffic patterns and assist in identifying devices on the network. These techniques allow for continuous monitoring of network traffic in real-time, providing granular insights into device activity.

In some embodiments, the agent may be positioned on a Switched Port Analyzer (SPAN) port to capture additional network traffic, further enhancing the discovery process. The system may also extend its discovery capabilities to wireless devices by incorporating protocols such as Wi-Fi, Bluetooth, Zigbee, and Z-Wave, commonly used in IoT environments. This allows for the detection of both authorized and rogue wireless devices, which may include unauthorized access points or devices attempting to infiltrate the network.

In certain implementations, the system may integrate with existing asset management systems, such as Configuration Management Databases (CMDBs), to cross-reference newly discovered devices with known asset inventories. This integration improves the accuracy of the discovery process by correlating newly identified devices with pre-existing records. In cloud environments, such as AWS, Azure, or Google Cloud Platform, the system may use specialized discovery techniques, such as APIs or network scanning, to detect virtual devices that may not be visible through traditional methods. This ensures that both physical and virtual devices are fully accounted for.

In addition to passive monitoring, the system may perform safe active scanning to discover open ports and services on devices connected to the network. These active scans are carefully designed to minimize the risk of disrupting network operations by using low-impact scanning techniques. For example, the system may limit the frequency and scope of active scans, ensuring that critical systems are not overwhelmed by network traffic or inadvertently affected.

The system may also act as a SYSLOG receiver, gathering logs from gateways and switches, or the system may access devices via Simple Network Management Protocol (SNMP) to collect relevant system data. DNS and DHCP logs may be analyzed to identify devices as they connect to the network, providing real-time insights into network activity. In some cases, the system may incorporate manual and customer-provided data to complement its automated discovery efforts. Customers may input data regarding specific devices, and this data can be cross-referenced with the system's findings to enhance the overall accuracy of the discovery stage.

Conventional network monitoring systems typically rely on centralized log analysis or generic packet inspection. Such approaches may detect anomalous behaviors but do not automatically reconfigure network infrastructure in real time to contain threats. As a result, network exposure windows remain large, and unmanaged devices are often left unprotected. The disclosed systems improve the functioning of the computer network itself by dynamically altering network segmentation policies in direct response to real-time device behavior, thereby reducing lateral movement risk without manual administrator intervention.

### Identification Stage

After the discovery stage, the system may proceed to an identification stage, in which advanced techniques are employed to classify and identify devices on the network. One embodiment may use machine learning and AI algorithms to improve the accuracy of device identification. These algorithms may classify devices based on observed behaviors, continuously improving as more data is gathered from network traffic. The system may also detect behavioral anomalies, identifying devices that deviate from expected patterns, which may signal the presence of rogue or compromised devices.

In addition to machine learning, the system may perform hardware fingerprinting, which involves analyzing unique attributes such as MAC addresses, clock skew, or variations in the implementation of TCP/IP stack behavior. These attributes are often distinct to specific manufacturers or device models and can serve as reliable identifiers. For example, subtle differences in packet timing or transmission patterns may help identify the specific make and model of a device. Advanced protocol analysis may also be performed to examine nuances in device behavior, further refining the identification process.

The system may also inspect SSL/TLS certificates and encryption keys used by devices to extract identifying information, such as the device's type, firmware version, or manufacturer. In certain embodiments, the system may collaborate with device vendors to access proprietary identification data through APIs or databases, allowing for even more accurate classification of network devices. For example, the system may query manufacturer-specific databases to retrieve detailed device specifications that are not readily available through traditional scanning techniques.

In some scenarios, the system may take on the role of the device's gateway, assuming control over its DHCP settings to monitor outbound traffic. This allows for closer observation of the device's behavior, providing more accurate identification. The system may also incorporate manual and customer-provided data into the identification process, allowing administrators to input details about known devices or device categories. This combination of automated identification and manual input ensures that even highly specialized or non-standard devices are properly classified.

### Profiling Stage

Once devices are identified, the system may proceed to a profiling stage, where the system may establish dynamic profiles for each device based on its observed behavior over time. These profiles may account for various factors, such as the time of day, the role of the user interacting with the device, and the environmental context in which the device operates. The system continuously updates these profiles as devices evolve, such as when they undergo firmware updates or configuration changes. This profiling stage enables the system to track changes in device behavior and detect any deviations from established norms.

In one embodiment, the system may incorporate policy-based profiling, allowing administrators to define expected behaviors for specific device types or groups. For example, an administrator may specify that certain IoT devices should only communicate with specific cloud endpoints. The system may then monitor these devices for any deviations from the predefined policies, triggering alerts or initiating protective actions if abnormal behavior is detected.

The system may also incorporate User and Entity Behavior Analytics (UEBA) to monitor interactions between users and devices, providing an additional layer of security. For example, the system may detect unusual login attempts or unauthorized access to sensitive data based on the user's typical behavior. By combining device profiling with device behavior analysis, the system offers a comprehensive solution to detecting insider threats and potential misuse.

The system may integrate external threat intelligence feeds, which provide real-time data on known malicious actors, IP addresses, or compromised devices. These feeds may be used to enrich device profiles, allowing the system to flag devices that are communicating with known malicious endpoints or displaying suspicious behavior associated with known attack patterns.

The systems, devices, and method for dynamically managing network devices may proceed through several stages, each may be for ensuring that both managed and unmanaged devices are continuously monitored, identified, profiled, and protected.

The agent may interface directly with network switches via SPAN or TAP ports, receiving raw Layer 2 frames. Modifications to network segmentation policies may be pushed to the switches through SDN APIs or CLI commands, altering VLAN assignments and access-control lists in the forwarding plane. These interactions occur at the network infrastructure level, improving real-time responsiveness to anomalous device behavior.

### Deploying an Agent to Monitor Network Traffic

The process may begin with deploying an agent within the network to monitor traffic. This agent may serves as a sentinel, positioned strategically within the network infrastructure, and is responsible for collecting data from various network devices. The agent may interact with both managed devices (e.g., servers, desktops) and unmanaged devices (e.g., Internet of Things (IoT) devices, sensors). The agent might not only gather data but also operate seamlessly across the network to ensure the agent captures a complete picture of the environment.

The agent may establish communication channels and initiates traffic monitoring, setting the foundation for the subsequent tasks. The agent may also collect both metadata and raw data from network traffic, for the system's passive monitoring and device discovery phases.

### Performing Passive Network Monitoring

Passive network monitoring may follow the agent deployment. This step may help ensure the system can analyze traffic without actively probing devices, thus avoiding disruptions. The system may employ deep packet inspection (DPI) to scrutinize the contents of network traffic. DPI may allow the system to detect protocols, identify applications, and observe behavior patterns from a wealth of network layers.

Alongside DPI, flow analysis protocols, such as NetFlow or sFlow, may be used to examine the traffic's metadata. Flow analysis may focus on patterns such as source and destination addresses, port numbers, and the volume of data being transferred. This may provide insights into network usage trends and can highlight unusual activity without requiring deep dives into every packet. By combining DPI and flow analysis, the system maintains high-fidelity observation without direct interference in the network's regular operations.

### Discovering Network Devices

The system may enter a discovery phase. Here, the data may be collected by the agent is used to detect network devices, including both wired and wireless devices. The system may be capable of identifying a wide range of device types—traditional managed endpoints as well as IoT devices and other peripherals.

Discovery techniques may involve analyzing network traffic signatures to recognize devices that may not be listed in traditional asset inventories. By observing network packets, the system may infer a device's presence even if the device has not announced itself explicitly through discovery protocols like DHCP. This may enable a comprehensive sweep of all connected devices, ensuring that even unmanaged or rogue devices are detected.

### Identifying Device Characteristics

Once devices are discovered, the system may move to the identification stage. An example embodiment may leverage hardware fingerprinting and advanced protocol analysis to distinguish each device on the network. Characteristics such as MAC addresses, clock skew, and variations in transmission behaviors are analyzed to create a unique device profile. These attributes may serve as fingerprints for each device, enabling the system to identify them accurately, even when devices appear similar.

For example, clock skew, which refers to the small timing deviations in how a device sends data packets, is often a subtle but reliable characteristic for distinguishing between devices of the same model. Similarly, transmission behaviors—how and when a device communicates—can reveal the device's purpose and sometimes the device's type, operating system, serial number and/or configuration and help distinguish the device from other devices performing different roles.

By combining multiple characteristics, the system may help ensure that devices are not only identified but also categorized based on their function, manufacturer, and operational role.

### Creating Dynamic Baseline Profiles

The next step may be creating dynamic baseline profiles for each device. These profiles might not be static. They may be continuously updated based on the device's observed behavior over time. The system establishes a norm for each device, incorporating various factors such as the time of day, frequency of communication, and typical network interactions.

Over time, these baseline profiles may evolve as the system learns more about each device's normal behavior. Any deviation from this baseline is recorded, and the system prepares for the next step: anomaly detection. The dynamic nature of these profiles ensures that devices which undergo firmware updates or changes in use (e.g., devices in different network zones) are accurately tracked without generating false alarms.

### Detecting Anomalies in Device Behavior

Once the dynamic profiles are established, the system may continuously compare each device's current behavior against the device's baseline. This is crucial for identifying potential security threats. Anomalies may be flagged when devices deviate from their expected behavior, such as communicating with previously unknown external IP addresses, sending an unusual amount of data, or operating at odd hours.

For instance, when a network printer suddenly attempts to communicate with a remote server, which is outside the network printer's normal operating parameters, the system may detect this anomaly. Such anomalies can signify security risks, including compromised devices or attempts at unauthorized access.

### Applying Network-Layer Protections

In response to detected anomalies, the system may apply network-layer protections. These protections may involve dynamically adjusting network segmentation policies based on the severity and type of detected threat. The system may use DHCP-based micro-segmentation, which involves assigning devices to small, isolated subnets. This strategy may help ensure that even if a device is compromised, the device cannot communicate freely across the network, thereby containing potential threats.

The system might also restrict the device's access to sensitive parts of the network or impose stricter traffic filtering rules to prevent malicious data exfiltration or communication with other compromised devices.

### Isolating Network Devices

The method may also involve isolating one or more network devices that exhibit suspicious or anomalous behavior. Isolation can take several forms. For example, the system may place the device into a quarantined subnet, where the device may be limited to interacting only with the system for further analysis. Alternatively, isolation might involve internal traffic blocking, where the device is prevented from communicating with other devices within the network, effectively neutralizing any immediate threats.

Isolation may remain a temporary but powerful measure, keeping potentially compromised devices contained until further investigation is complete. Throughout this process, the system may continue monitoring the device, ready to respond to further behavior changes or to reintegrate the device once the threat is resolved.

### Additional Considerations

Throughout this process, the system may utilize advanced features like Software-Defined Networking (SDN) to dynamically adjust network segmentation policies in real-time or integrate with external threat intelligence feeds to enrich the system's baseline profiles with up-to-date knowledge about known malicious actors and vulnerabilities. These measures may help ensure the method remains adaptable and effective in rapidly changing network environments, providing comprehensive and dynamic protection for all devices on the network.

### Protection Stage

In some implementations, the disclosed system reduced the mean time to isolate anomalous devices from minutes to seconds and decreased unauthorized lateral communications by up to 98%, demonstrating a measurable technical improvement to network security performance.

Enforcement Loop. Upon detection of an anomaly, the system computes a risk score and programmatically updates forwarding policy: (i) issue SDN/CLI updates to modify ACL/VLAN state and/or DHCP assignments; (ii) place the device into a quarantine or micro-segment that limits reachability to a designated gateway and any explicitly permitted endpoints; and (iii) feed back the outcome (alerts, flows, confirmations) into the per-device baseline to refine future thresholds. This closed-loop enforcement reduces lateral-movement paths and decreases mean time to isolation from minutes to seconds in some implementations.

Following the profiling stage, the system may implement network-layer protections to isolate devices based on their profiles. In one embodiment, the system may employ Software-Defined Networking (SDN) to dynamically adjust network segmentation policies in response to detected threats or changes in device behavior. This allows for real-time segmentation without manual intervention, ensuring that compromised devices are quickly isolated to prevent the spread of malware or unauthorized access to sensitive systems.

The system may also adopt a Zero Trust architecture, requiring each device to authenticate and be authorized before gaining access to the network. This model ensures that even devices within the internal network are subject to strict access controls. Devices that fail to meet the required security standards may be automatically quarantined or assigned to restricted network segments.

In some cases, the system may automatically generate Virtual Local Area Networks (VLANs) to isolate devices at Layer 2 of the network. For example, the system may create individual VLANs for critical infrastructure devices, ensuring that compromised devices cannot communicate with essential systems. Alternatively, the system may implement DHCP-based micro-segmentation, where devices are assigned to isolated subnets. This method may involve using /30 subnets, which provide two usable IP addresses—one for the device and one for the designated gateway. In this configuration, the device may only communicate with specified endpoints, and all other traffic is restricted.

The system may also employ behavioral firewalls to monitor devices for anomalous activity. These firewalls may analyze real-time device behavior and respond to deviations by automatically isolating or quarantining the device. For example, if a device that typically communicates with a specific set of cloud services suddenly attempts to access unauthorized systems, the firewall may block the connection and notify network administrators.

In some embodiments, the system may perform encrypted traffic analysis, which involves analyzing traffic patterns without decrypting the contents of the communication. This method preserves privacy while still detecting anomalies based on metadata and transmission behaviors. For instance, the system may detect unusual traffic volumes or connection attempts, even if the contents of the traffic are encrypted.

The system may also assist with regulatory compliance by offering features such as audit logging, data anonymization, and compliance reporting for frameworks like GDPR or HIPAA. These features ensure that organizations using the system can meet legal and regulatory requirements while maintaining comprehensive network security. The system may provide detailed audit logs of all network activity, allowing for easy reporting and forensic analysis if a security incident occurs.

At the time of filing, the combination of (i) passive agent-based Layer 2 monitoring, (ii) hardware fingerprinting using clock skew and transmission behavior analysis, and (iii) dynamic DHCP-based micro-segmentation with SDN integration was not a standard or routine practice in enterprise network security. Existing systems typically relied on static segmentation and did not adapt in real time based on per-device behavioral baselines. The disclosed approach represents a non-conventional and technical improvement to network security architecture.

### Device Interaction and Policy Management

The system includes a customizable user interface that allows network administrators to monitor real-time device activity, adjust security policies, and view alerts generated by the system. The dashboard may include various modules such as device discovery status, risk scoring, anomaly detection, and policy simulation. Administrators may create, modify, and apply security policies directly from the interface, with the option to simulate the impact of new policies before deployment. The interface supports role-based access control (RBAC), allowing different levels of permissions for devices based on their roles within the organization. Push notifications may be sent through APIs or webhooks to alert administrators to critical security events or anomalies in real-time.

An example system architecture may include an agent that may be deployed within a network, collecting data from sources such as DPI, flow analysis protocols, and wireless network integrations. The data collected by the agent may then be processed by an intelligence system, which may reside in a cloud platform or be hosted on-premises. Devices discovered by the agent may be analyzed and profiled to determine their characteristics and security posture.

In an example of the profiling process. The system may establish baseline profiles for each device based on the device's observed behavior. These profiles may be continuously updated as the device evolves, incorporating new data from firmware updates or configuration changes. If any anomalies are detected, the system may alert administrators or automatically isolate the device to prevent further risk.

The disclosed methods improve the functioning of the computer network itself, rather than merely automating mental processes or performing business rules on a generic computer. All detection and enforcement actions occur automatically in real time, without human decision-making in the loop. Although individual components such as network switches, DHCP servers, and monitoring agents were known, their coordinated operation under real-time behavioral control as disclosed herein was not routine, conventional, or generic.

An example network protection mechanism may include devices that may be assigned to VLANs or micro-segmented subnets, where their communication may be restricted based on security policies. SDN components may dynamically manage the segmentation policies, ensuring that network security remains adaptive to changing conditions while maintaining operational efficiency.

The present invention provides a practical and technical solution to the challenges of securing complex, dynamic networks. By combining discovery, identification, profiling, and protection processes, the system offers comprehensive security for both managed and unmanaged devices while maintaining network performance and adaptability to future technological advancements.

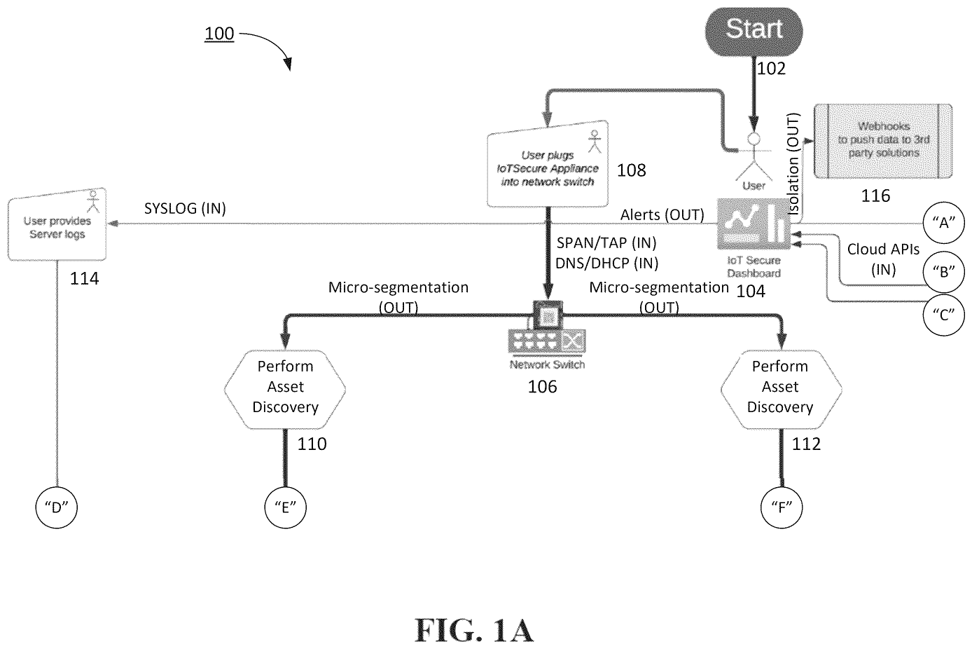

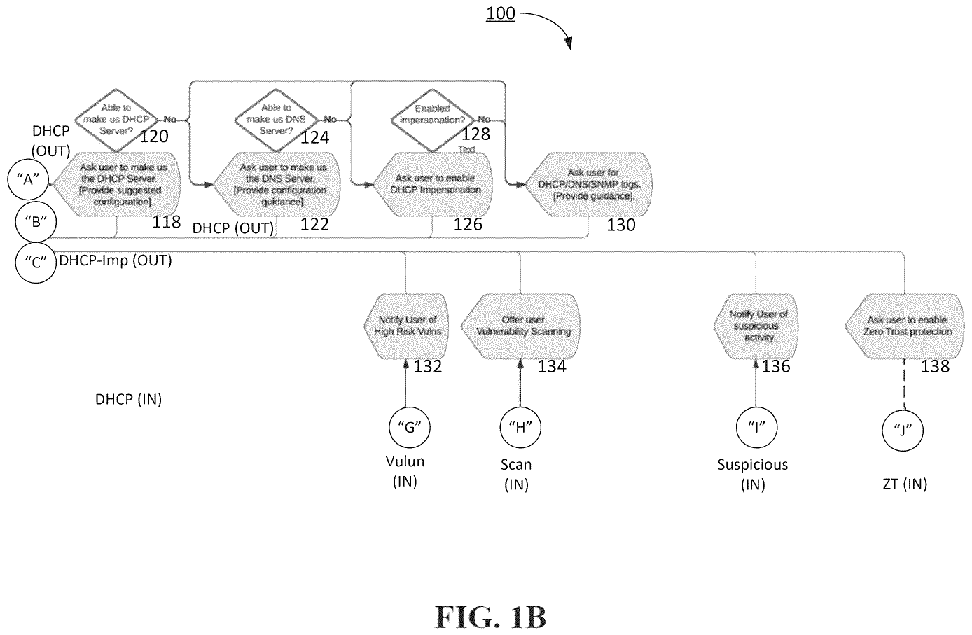

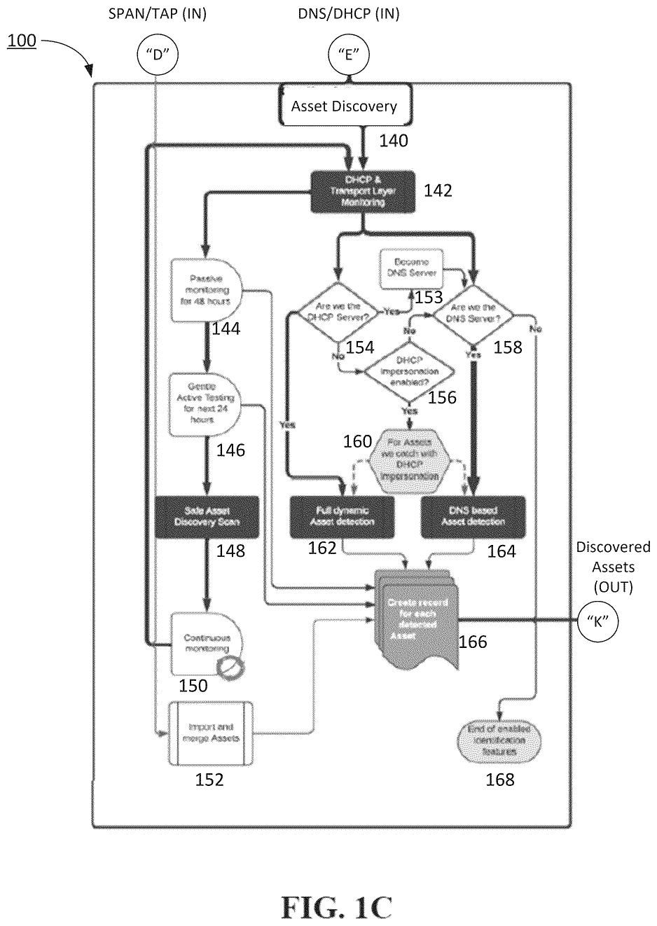

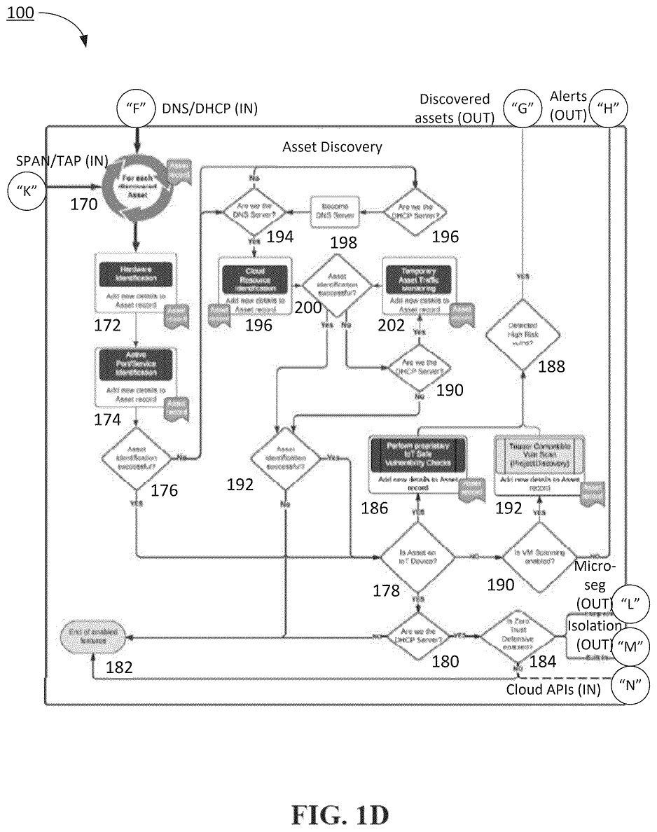

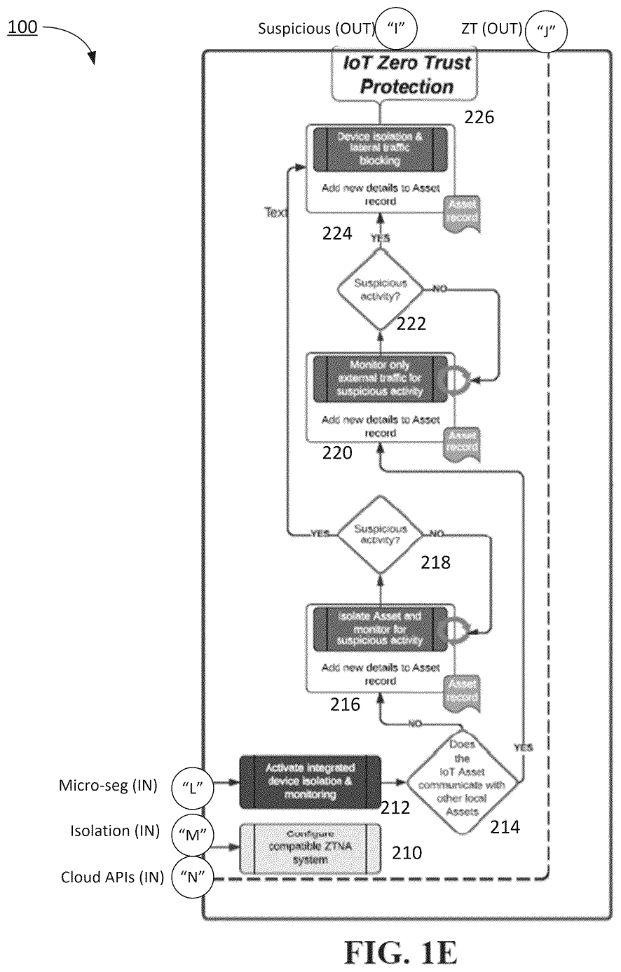

FIGS. 1A-1E illustrate an example diagram illustrating the process 100 of comprehensive asset discovery, identification, and monitoring in accordance with the systems and methods described herein. Each figure highlights different steps in the system's process, from initial network integration to asset discovery and dynamic protection.

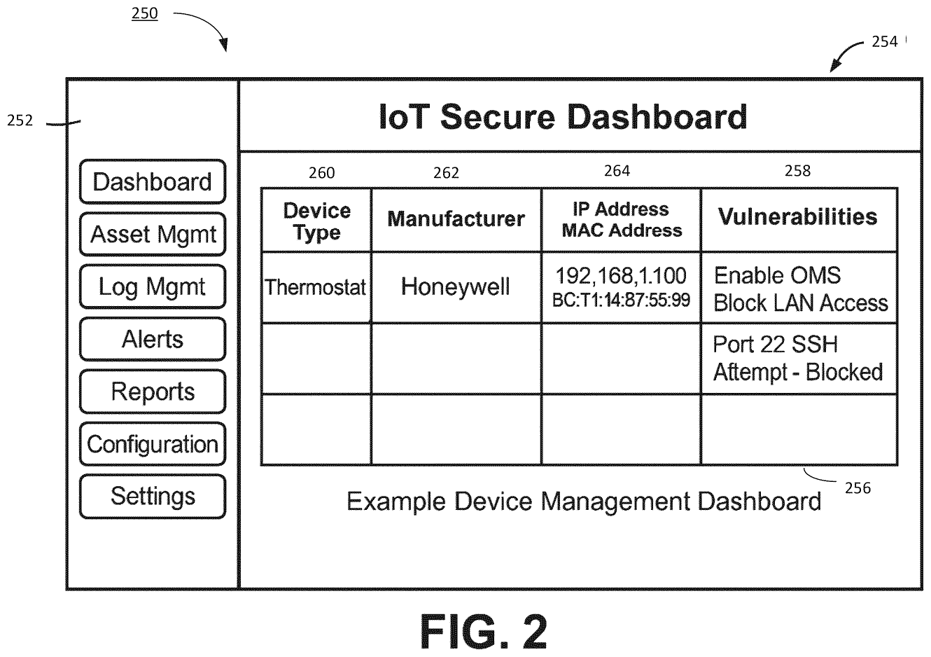

In FIG. 1A, at the start 102, a user may connect an IoT secure appliance to a network switch 106. For example, the user may plug the IoT Secure application into network switch 106 (108). In this method, the system performs comprehensive asset discovery 110 and identification 112. The IoT secure dashboard 104 (in IoT secure appliance 104, see also FIG. 2) is also introduced, providing users with server logs 114 and web hooks 116 to push data to third-party solutions. This dashboard interacts with the user, as discussed in FIG. 1B (connectors “A,” “B,” “C,” “D,” “E,” “F”).

FIG. 1B illustrates the IoT secure dashboard guiding the user to configure the DHCP server 118, if available, or determine whether the system can configure a DHCP server 120. If the system cannot configure a DHCP server, the system may prompt the user to configure the DNS server and provides relevant guidance 122. If DNS configuration is not feasible or available 124, the system may suggest enabling DHCP impersonation 126. If impersonation is not possible or not enabled 128, the system requests DHCP/DNS/SNMP logs 130 and offers further guidance. In cases where DHCP or DNS server creation fails, the process may skip ahead to subsequent steps. Determining an inability to configure a DHCP server 120, an inability to configure a DNS server 124, or if impersonation is not enabled 128 may lead directly to the system requesting DHCP/DNS/SNMP logs 130 and offering further guidance. Notifications about high-risk vulnerabilities 132, vulnerability scanning 134, suspicious activity 136, or enabling zero-trust protection 138 are sent to the IoT secure dashboard for real-time updates (connectors “A,” “B,” “C,” “G,” “H,” “I,” “J”).

The performance of comprehensive asset discovery 110 from FIG. 1A is further detailed in FIG. 1C. The stage begins with Radical Asset Discovery 140 and DHCP and transport-layer monitoring 142, followed by passive monitoring for 48 hours 144 and low-impact active probing for 24 hours 146. A low-impact asset discovery scans 148 may be performed, with continuous monitoring 150 and an option to import and merge assets 152. From the monitoring block 142, the system may evaluate several branches: it may become a DNS server 153, it may determine if it is the DHCP server 154 When yes, continuous asset detection 162 may occur. When no, a check if the DHCP impersonation is enabled may occur 156, and/or a check if it is the DNS server may occur 158. When yes, DNS-based asset detection 164 may occur. If DHCP impersonation is enabled 156, the system may proceed for assets to catch with DHCP impersonation 160 to continuous asset detection 162. Outputs from 162 and 164 lead to create a record for each detected asset 166, after which the flow continues to FIG. 1D (connector “K”). If the DNS-server check 158 is negative and no other path applies, the flow reaches end of enabled identification features 168. (Entry points from FIG. 1A use connectors “D” and “E.”)

FIG. 1D focuses on Radical Asset Identification. For each discovered asset, hardware identification is performed 170, adding new details to the asset record 172. Active port and service identification may also be carried out 174. When asset identification is successful 176, if the asset is identified as an IoT device 178, the system checks if the asset functions as a DHCP server 180. If the asset is not a DHCP server, the process concludes 182. If the asset is a DHCP server, the system determines if zero-trust defenses are enabled 184, ending the process if they are not 182; if enabled, the flow continues to isolation/monitoring in FIG. 1E (“G,” “H,” “L,” “M”). (Entry from the prior figures via “F,” “K,” “N.”)

If an asset is classified as an IoT device, the system performs a IoT-focused vulnerability assessment and updates the asset record with new details 186. If a high-risk vulnerability is detected 188, the system notifies the user, as illustrated in FIG. 1B. When VM scanning 190 is not enabled, the system offers a vulnerability scan. If VM scanning 190 is active, the system triggers compatible vulnerability scan project discovery and adds relevant data to the asset record 192.

When asset identification is unsuccessful, the system checks if the device functions as a DNS server 194. If so, cloud resource identification is performed 196, and the record is updated. If the device is not a DNS server 194, the system checks for DHCP server functionality 196. If successful, the flow determines whether the system can become a DNS server 198. (and becomes one if appropriate 198); otherwise the path evaluates whether we are the DHCP server 196. A “Yes” at 196 initiates temporary asset traffic monitoring 202, which feeds into the VM-scanning evaluation 190; a “No” at 196 proceeds to the central decision 200 (“Asset identification successful?”). Where identification remains unsuccessful 200 (No), temporary asset traffic monitoring is initiated 202 (again flowing to 190); where identification succeeds 200 (Yes), processing continues with device-type evaluation 178.

FIG. 1E demonstrates the system integrating with a compatible Zero Trust Network Access (ZTNA) system, which may be configured 210, then activates integrated device isolation & monitoring 212 (entry from FIG. 1D via connectors “L,” “M,” “N”). The system determines whether the IoT asset communicates with other local assets 214. If no local communication is detected, the asset is isolated and monitored for suspicious activity 216, after which the system evaluates Suspicious activity? 218 (No→continue monitoring 216; Yes→device isolation & lateral traffic blocking 224). If the IoT asset does communicate locally, the system monitors only external traffic for suspicious activity 220, then evaluates Suspicious activity? 222 (No→continue 220; Yes→224). Status/alerts may be surfaced through the dashboard in FIG. 1B via connectors “I,” “J.” The enclosing IoT Zero Trust Protection flow is indicated at 226.

The preceding disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it is understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

### Dynamic Profiling and Anomaly Detection

The system's dynamic profiling capabilities extend beyond initial device identification by continuously updating profiles based on ongoing behavior and contextual factors. For instance, devices may be categorized not only by their hardware and software attributes but also by their real-time interactions with other devices within the network. These dynamic profiles consider aspects such as time-based patterns, usage statistics, and network location, allowing for more granular and adaptive security measures.

The use of machine learning algorithms in profiling enables the system to adapt as the system observes more data, identifying baseline behaviors for each device and flagging deviations from these behaviors as potential anomalies. Over time, the system becomes more precise in differentiating between legitimate changes in device behavior (such as firmware updates or new user actions) and suspicious activities that may indicate security threats. This learning-based approach reduces false positives and increases the system's ability to proactively respond to emerging threats.

Anomalies may include unexpected communication patterns, unauthorized attempts to access restricted network segments, or a significant increase in data traffic volume. In response to these anomalies, the system can automatically adjust network-layer protections, such as isolating the device or tightening access controls. In some cases, the system may generate recommendations for human intervention, providing administrators with detailed insights into the anomalous behavior and suggesting corrective actions.

As an additional layer of security, the system integrates external threat intelligence feeds, enabling the system to cross-reference real-time data on known vulnerabilities, attack vectors, and malicious actors. This integration allows for rapid identification of devices that may be communicating with known threat actors or displaying behaviors consistent with known attack patterns, such as distributed denial-of-service (DDOS) attacks, malware propagation, or data exfiltration attempts.

### Integration With Zero Trust Architecture

One significant advantage of the system lies in the system's compatibility with Zero Trust Architecture (ZTA) principles. As part of this framework, the system enforces continuous verification of every device's identity, regardless of the system's location within the network. Devices are not trusted by default simply because they are within the network perimeter; instead, they are subject to authentication and authorization checks each time they attempt to access resources.

The system's ZTA integration allows for the implementation of granular access controls, where each device's privileges are tailored to the device's current role and behavior. For instance, an IoT device responsible for environmental monitoring may be restricted to interacting only with specific cloud endpoints related to the IoT device's function, while all other traffic is blocked. This fine-tuned approach minimizes the risk of lateral movement by malicious actors, who may otherwise attempt to exploit vulnerable devices within the network to gain broader access.

In scenarios where devices fail security checks or exhibit suspicious behavior, the system can enforce isolation at the network level. This may involve moving the device to a quarantined network segment, applying stricter access controls, or initiating internal traffic blocking measures. These protections are applied dynamically, without requiring manual intervention from network administrators, thus allowing the system to respond in real time to potential threats.

### Scalability and Cloud Integration

The system's architecture may be designed to scale with the size and complexity of the network the system is deployed in. Whether managing a small local network or a global enterprise infrastructure, the system can dynamically adjust its monitoring and protection strategies based on the network's evolving needs. This scalability extends to cloud environments, where the system interfaces with public, private, or hybrid clouds to discover and protect virtual devices.

### Example Scenarios

Hospital MRI: An unmanaged MRI scanner periodically transmits to a vendor cloud. The system fingerprints the device (MAC-layer attributes, clock-skew estimate, transmission-behavior signature), builds a baseline of outbound intervals and destinations, and flags an anomaly when the scanner initiates lateral SMB traffic to a nurse-station PC. Policy is updated in real time to place the device in a micro-segment permitting only its cloud endpoints and the designated gateway; lateral SMB is denied.

Factory PLC: A PLC controlling a packaging line exhibits a new bursty pattern toward an unknown on-prem server. The system detects deviation from the PLC device-type baseline, updates ACL/VLAN policy via SDN, and quarantines the PLC to a diagnostics segment while allowing vendor maintenance access.

Smart Thermostat: A building thermostat begins beaconing at atypical hours to a newly registered domain. Encrypted-traffic analysis (no decryption) identifies abnormal timing/length sequences and endpoint reputation. The device is auto-isolated to a /30 DHCP micro-segment that permits only the gateway and a whitelisted service.

Integration with cloud-based platforms, such as Amazon Web Services (AWS), Microsoft Azure, and Google Cloud Platform, allows the system to detect virtual machines, containers, and other cloud-native assets. These assets may be less visible to traditional network security tools, but through the system's use of APIs and network scanning techniques, they can be incorporated into the same dynamic discovery, profiling, and protection process that governs physical devices.

Additionally, the system's cloud integration provides organizations with the flexibility to host the intelligence system either on-premises or in the cloud, depending on their infrastructure preferences. Cloud-hosted deployments benefit from centralized management, global threat intelligence updates, and scalability across multiple regions, making cloud-hosted deployments suitable for organizations with distributed or hybrid environments.

FIG. 2 illustrates an example device management dashboard interface 250, in accordance with certain embodiments of the disclosed systems and methods. The dashboard interface 250 provides a graphical user interface through which network administrators can view, monitor, and manage network-connected devices. The interface includes a navigation panel 252, a header bar 254, and a device table 256.

The navigation panel 210 is positioned along the left side of the interface and may include selectable buttons or tabs for various administrative functions, such as “Dashboard,” “Asset Management,” “Log Management,” “Alerts,” “Reports,” “Configuration,” and “Settings.” Selection of any of these navigation options may display corresponding sub-interfaces or control panels, allowing the administrator to access different functional modules of the system.

The header bar 254, shown at the top of the interface, may display the system name (e.g., “IoT Secure Dashboard”) and may optionally include status indicators, user information, or global controls applicable across modules.

The device table 256 provides a structured display of network device information, including, in this example, columns for device type, manufacturer, IP and MAC address, detected vulnerabilities, applied or recommended policies, and recent activity logs. The vulnerability column 258 may list detected vulnerabilities or security conditions for each device, such as “Enable OMS,” “Block LAN Access,” or “Port 22 SSH Attempt-Blocked.”

As shown, each row of the device table 230 corresponds to a network device that has been discovered, identified, and profiled by the system. In one example row, the device type 260 is “Thermostat,” manufactured 262 by “Honeywell,” with an associated IP and MAC address 264, and entries under the vulnerability and activity columns reflecting security recommendations and recent traffic events. The information displayed may be updated dynamically as the system monitors device behavior, detects anomalies, and applies network layer protections as described above.

Although FIG. 2 illustrates one example layout, other embodiments may use different arrangements, additional columns, or alternative graphical formats. The illustrated layout is intended to exemplify how the system may provide administrators with actionable, structured information regarding network devices, vulnerabilities, and activity.

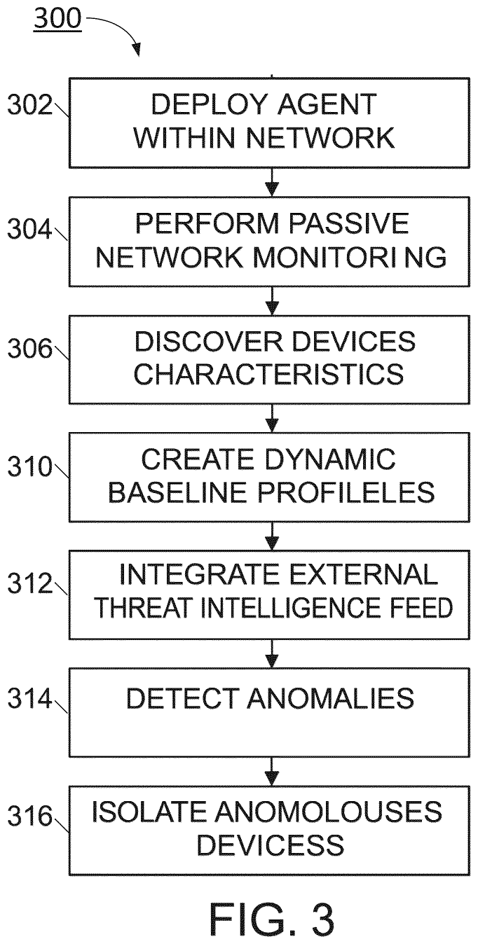

FIG. 3 illustrates an example method 300 for dynamically managing network devices in a computer network environment. The method 300 includes deploying an agent within a network to monitor network traffic (step 302), performing passive network monitoring (step 304), discovering devices based on collected data (step 306), identifying characteristics of the devices using hardware fingerprinting and protocol analysis (step 308), creating dynamic baseline profiles for the devices (step 310), integrating external threat intelligence feeds to enrich the profiles (step 312), detecting anomalies by comparing current behavior to the baseline profiles (step 314), applying network-layer protections in response to detected anomalies (step 316), and isolating anomalous devices (step 318). Each of these steps is described in greater detail below.

In step 302, the method includes deploying an agent within a network to monitor network traffic. In one embodiment, deploying the agent comprises installing a lightweight software component on a network switch, router, or dedicated monitoring appliance that is logically coupled to the network infrastructure. In another embodiment, deploying the agent includes configuring the agent to listen to mirrored traffic (e.g., via a SPAN or TAP port) and establishing secure communication channels between the agent and a backend processing system. The agent is configured to collect raw traffic data and metadata from both managed and unmanaged devices present on the network.

In some embodiments, the passive monitoring operates without decrypting application payloads. Deep packet inspection is limited to protocol headers, handshake metadata, and observable characteristics (e.g., timing, length sequences, directionality), while payload content remains opaque. For encrypted sessions, the system evaluates features such as record sizes, burst profiles, inter-arrival timing, and Server Name Indication (SNI) metadata, thereby enabling anomaly detection without decryption and preserving privacy and compliance requirements.

In step 304, the method includes performing passive network monitoring to analyze network traffic without active scanning. Passive monitoring may include observing packets transmitted on the network in real time, extracting header information, protocol fields, and timing characteristics without generating any additional network traffic. Passive monitoring may further include performing deep packet inspection or protocol inference to identify communication patterns, service banners, and handshake behaviors of connected devices. This allows the system to collect rich characterization data without disrupting existing network operations.

In step 306, the method includes discovering one or more network devices based on data collected by the agent during passive monitoring. Device discovery may include analyzing DHCP, DNS, and ARP traffic to identify wired and wireless devices present on the network, including both managed enterprise assets and unmanaged Internet of Things (IoT) devices. Device discovery may further include correlating multiple identifiers—such as IP addresses, MAC addresses, and hostnames—to produce a unified device record for each observed device. In some embodiments, discovery may also include querying cloud APIs to detect virtual devices operating in cloud environments.

In step 308, the method includes identifying characteristics of the one or more network devices using hardware fingerprinting and advanced protocol analysis. Identifying characteristics may include extracting unique device attributes such as Media Access Control (MAC) addresses, clock skew measurements, and variations in transmission behaviors, which together enable precise device fingerprinting. Identifying characteristics may further include analyzing SSL/TLS certificates, encryption keys, or protocol-specific fields to extract information about firmware versions, device types, and vendor-specific behaviors.

In step 310, the method includes creating dynamic baseline profiles for each of the one or more network devices, where the profiles are continuously updated over time. Creating baseline profiles may include establishing initial behavioral models for each device based on observed traffic patterns, communication endpoints, port usage, and data transfer volumes. Updating the baseline profiles may include incorporating contextual factors such as time of day, user roles, or operational context, allowing the baseline to evolve dynamically as the environment changes.

In step 312, the method includes integrating external threat intelligence feeds to enrich the dynamic baseline profiles. Integrating threat intelligence may include importing known malicious IP addresses, domain names, or digital signatures from external security sources and correlating them with device communications observed on the network. Integrating threat intelligence may further include augmenting device baselines with risk scores or flags when communications with known malicious endpoints are detected, thereby enhancing the system's ability to detect compromised or high-risk devices.

In step 314, the method includes detecting anomalies in device behavior by comparing current behavior to the dynamic baseline profiles. Detecting anomalies may include applying statistical deviation analysis, machine learning models, or rule-based detection engines to identify unusual communication patterns, deviations in traffic volume, or unexpected protocol usage. Detecting anomalies may further include triggering alert generation or classification of anomaly severity levels to support downstream automated protection actions.

In step 316, the method includes applying network-layer protections to the one or more network devices in response to detecting anomalous behavior. Applying protections may include dynamically adjusting network segmentation policies using DHCP-based micro-segmentation to assign affected devices to restricted subnets. Applying protections may further include leveraging Software-Defined Networking (SDN) controllers to adjust access control lists or routing rules in real time to limit the blast radius of potentially compromised devices.

In step 318, the method includes isolating one or more network devices that have been identified as anomalous. Isolating devices may include revoking the device's access to production networks and redirecting traffic to quarantine segments or honeypots for further inspection. Isolating devices may further include initiating automated notifications to security teams, logging forensic data for incident response, and optionally invoking remediation workflows such as firmware patching or credential rotation.

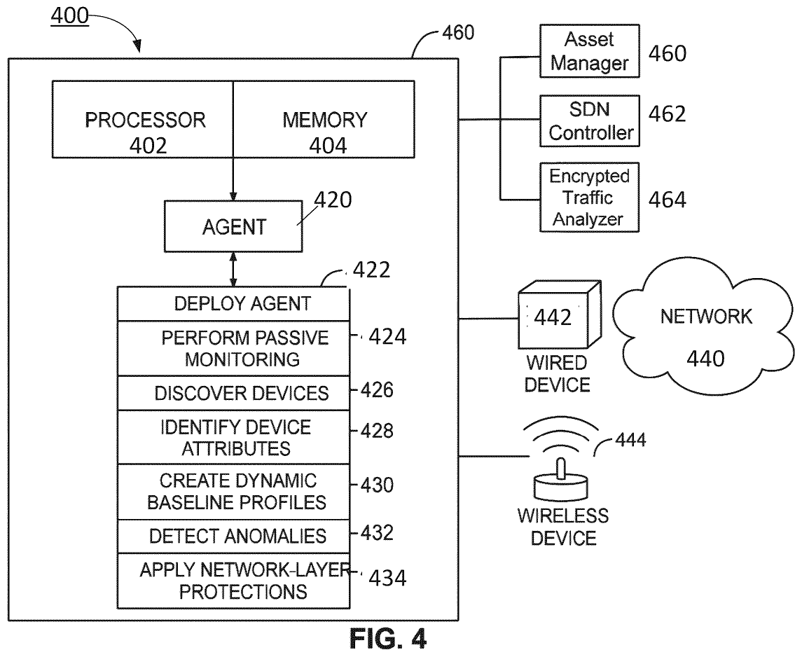

FIG. 4 illustrates an example system 400 for dynamically managing network devices in accordance with various embodiments. The system 400 includes a processor 402 and a memory 404, which stores instructions that, when executed by the processor 402, may configure the system to perform network monitoring, device discovery, fingerprinting, profiling, anomaly detection, and network-layer protection operations. The processor 402 and memory 404 may be coupled via one or more buses or communication channels, and together they provide the computational and storage resources to execute the functional modules described herein.

The memory 404 may store instructions and data structures implementing a set of functional modules. In the illustrated embodiment, the functional modules include an agent 420, a deployment agent 422, a passive network monitoring module 424, a device discovery module 426, a device identification module 428, a baseline profiling module 430, an anomaly detection module 432, and a network-layer protection module 434. Each of these modules corresponds to a portion of method 300 (see FIG. 3) and cooperates to dynamically discover and protect devices connected to a network 440.

The agent deployment module 422 may be configured to deploy and manage an agent 420 within a monitored network 440. The agent 420 may be installed on a network switch, router, monitoring appliance, or virtual network tap. The agent 420 may be configured to collect traffic and metadata from both wired devices 442 and wireless devices 444, including managed and unmanaged devices, without requiring installation on each device. The agent can operate in passive mode, monitoring traffic through port mirroring, SPAN/TAP interfaces, or inline packet inspection, depending on the deployment environment.

The passive network monitoring module 424 may be configured to analyze network traffic collected by the agent 420 without initiating active scans. This module may parse packet headers, timing information, protocol exchanges, and communication patterns to build a rich view of the network environment. It may support both Layer 2 and Layer 3 traffic analysis and can be configured to run continuously to ensure real-time situational awareness.

The device discovery module 426 may be configured to identify devices on the network 440 by analyzing the data collected by the agent 420. Device discovery may include evaluating DHCP, DNS, ARP, and broadcast traffic to detect both wired and wireless endpoints, as well as correlating multiple identifiers (e.g., MAC addresses, IP addresses, hostnames) to form unified device records. In some embodiments, the device discovery module 426 may be further configured to integrate with asset management systems 460 to cross-reference discovered devices with existing asset inventories, thereby enriching device records with ownership, classification, or policy metadata.

The device identification module 428 may be configured to perform fingerprinting operations by analyzing unique device attributes such as Media Access Control (MAC) addresses, clock skew, or variations in transmission behaviors. This module may also access cryptographic identifiers (e.g., SSL/TLS certificates) or protocol-specific fields to extract additional characteristics such as firmware version or vendor type. In some embodiments, the system 400 further comprises a SYSLOG receiver that collects logs from gateways and switches to support enhanced identification and profiling of the devices.

The baseline profiling module 430 may be configured to create dynamic baseline profiles for each device. These profiles are generated from observed device behavior over time and may include typical traffic volume, communication endpoints, and temporal patterns (e.g., time-of-day behavior). The profiles are continuously updated to account for contextual factors such as operational changes, user roles, or environmental factors. The baseline profiling module 430 may also integrate external threat intelligence feeds to enrich the baseline profiles by identifying known malicious endpoints or behaviors associated with specific device classes.

The anomaly detection module 432 may be configured to detect deviations between current device behavior and the dynamic baseline profiles. Detection techniques may include statistical deviation analysis, rule-based engines, or machine learning algorithms. When anomalies are detected, the system may classify the anomalies by severity level and generate alerts or trigger downstream protection actions.

The network-layer protection module 434 may be configured to apply network protections in response to detected anomalies. These protections may include dynamically adjusting network segmentation policies and assigning devices to micro-segmented subnets using DHCP-based micro-segmentation. In some embodiments, the network-layer protection module 434 may further interface with a Software-Defined Networking (SDN) controller 462 to dynamically adjust network policies and isolate compromised devices in real time. Additionally, the system may include an encrypted traffic analyzer 464, which is configured to detect anomalies in encrypted traffic patterns without decrypting the contents, thereby preserving privacy while still enabling detection of malicious behaviors.

Network 440 may represent any combination of wired and wireless communication infrastructure, including local area networks (LANs), wide area networks (WANs), or hybrid environments. Wired devices 442 may include servers, printers, or workstations, while wireless devices 444 may include IoT sensors, cameras, or smart appliances. The agent 420 may observe traffic exchanged between these devices and external networks, feeding this information back to the processor 402 and memory 404 for analysis.

Although FIG. 4 illustrates one example configuration, alternative embodiments may combine or split functional modules, use distributed architectures (e.g., cloud-based processors), or incorporate additional sensors and analytics components. The illustrated system 400 represents one suitable implementation for carrying out the method 300 described with respect to FIG. 3.

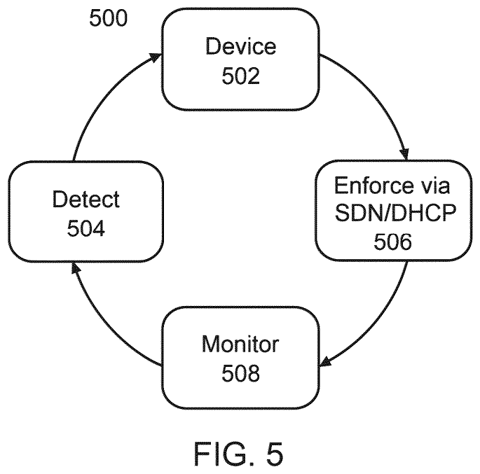

FIG. 5 illustrates an example zero-trust enforcement loop 500 in accordance with certain embodiments of the disclosed systems and methods. The loop begins with a device 502, which may include any network-connected endpoint such as a user workstation, mobile device, server, sensor, or Internet-of-Things (IoT) or operational technology (OT) asset. The device 502 generates network traffic and participates in communications that are observed by the system. A detection module 504 analyzes traffic patterns, metadata, and contextual information associated with the device 502 to identify attributes, behaviors, and potential anomalies. Based on detection results, an enforcement module 506 applies security controls—such as software-defined networking (SDN) rules, DHCP assignments, VLAN segmentation, or access control list (ACL) updates—to dynamically adjust the network posture of the device 502. A monitoring module 508 continuously observes the device's activity after enforcement, collecting telemetry to validate policy effectiveness, detect deviations, and feed subsequent detection operations. The loop 500 thus represents a continuous cycle of device observation, detection, enforcement, and monitoring that provides adaptive zero-trust security over time.

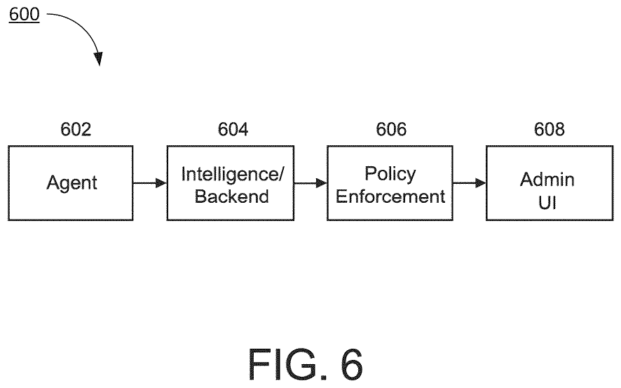

FIG. 6 illustrates an example system architecture 600 for dynamically managing network devices in accordance with certain embodiments of the disclosed systems and methods. The architecture 600 includes an agent 602, an intelligence and backend system 604, a policy enforcement system 606, and an administrative user interface (UI) 608, arranged in a data flow that supports discovery, identification, profiling, anomaly detection, and protection functions across a computer network.

The agent 602 is deployed within the monitored network and is configured to collect network traffic data from a plurality of sources, including SPAN/TAP ports, DNS/DHCP logs, SYSLOG feeds, and wireless protocol integrations, without requiring installation on individual endpoints. The agent 602 may be implemented as a physical appliance, a virtual machine, a containerized software process, or other deployment form suitable for the network environment. In operation, the agent 602 passively monitors Layer 2 and Layer 3 network traffic, performing deep packet inspection (DPI) and flow analysis to generate a rich set of metadata describing wired and wireless devices present on the network.

The collected data is securely transmitted to the intelligence and backend system 604, which may be hosted in a cloud environment or on-premises infrastructure. The intelligence and backend system 604 performs core analytics functions, including device discovery, hardware fingerprinting, behavioral profiling, anomaly detection, and threat intelligence correlation. The backend system may use advanced machine learning models to identify device characteristics such as Media Access Control (MAC) addresses, clock skew, protocol-level idiosyncrasies, or encrypted traffic patterns. Dynamic baseline profiles are created and continuously updated for each discovered device, enabling the system to detect deviations from expected behavior in real time.

Upon detecting anomalies or changes in device posture, the backend system 604 generates actionable security decisions and transmits these to the policy enforcement system 606. The policy enforcement system 606 may interface with network infrastructure elements, such as switches, routers, or Software-Defined Networking (SDN) controllers, to apply network-layer protections. These protections may include assigning devices to micro-segmented subnets using DHCP-based segmentation, dynamically adjusting VLAN assignments, updating access control lists (ACLs), or triggering isolation mechanisms to quarantine anomalous devices.

The administrative UI 608 provides network administrators with visibility and control over the end-to-end security process. Through the UI 608, administrators may view device discovery status, anomaly alerts, segmentation policies, and audit logs. The UI may support role-based access control (RBAC) and offer policy simulation tools that enable administrators to preview the effects of network policy changes before deployment. Alerts and notifications may be delivered through webhooks, APIs, or integrated security dashboards, providing real-time situational awareness and operational feedback loops.

In one embodiment, the components shown in FIG. 6 are connected by secure communication channels and may operate in a distributed or centralized configuration depending on network topology. The modular architecture allows the system to scale from small local deployments to large enterprise or hybrid cloud environments. Collectively, the agent 602, intelligence and backend system 604, policy enforcement system 606, and administrative UI 608 form a comprehensive architecture that improves the functioning of the computer network itself by dynamically adapting network segmentation and security policies based on real-time device behavior.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like) and may be used interchangeably with “one or more.” The phrase “only one” or similar language is used where only one item is intended. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

One or more elements or aspects or steps, or any portion(s) thereof, from one or more of any of the systems and methods described herein, may be combined with one or more elements or aspects or steps, or any portion(s) thereof, from one or more of any of the other systems and methods described herein and combinations thereof, to form one or more additional implementations and/or claims of the present disclosure.

One or more components, steps, features, and/or functions illustrated in the figures may be rearranged and/or combined into a single component, block, feature, or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this Application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A computer-implemented method for dynamically managing one or more network devices, comprising:
deploying an agent within a network to monitor network traffic, the agent configured to collect data from the one or more network devices, the one or more network devices comprising managed devices and unmanaged devices;
performing passive network monitoring to analyze the network traffic without active scanning;
discovering the one or more network devices based on data collected by the agent;
identifying characteristics of the one or more network devices using hardware fingerprinting and protocol analysis, the identifying including analyzing MAC-layer attributes, clock-skew estimates, and transmission-behavior signatures;
creating dynamic baseline profiles for the one or more network devices, the dynamic baseline profiles being continuously updated based on observed device behavior over time;
detecting anomalies in device behavior by comparing current behavior to the dynamic baseline profiles;
applying network-layer protections to the one or more network devices in response to the detecting, the network-layer protections including assigning one or more devices to micro-segmented subnets using DHCP-based micro-segmentation and dynamically adjusting network-segmentation policy; and
isolating one or more network devices in response to detecting anomalous behavior.

2. The method of claim 1, wherein dynamically adjusting the network-segmentation policy comprises issuing policy updates to a Software-Defined Networking (SDN) controller to modify one or more access-control lists or VLAN assignments in real time.

3. The method of claim 1, wherein discovering the one or more network devices further comprises querying one or more cloud platform application programming interfaces (APIs) to detect virtual or ephemeral assets in Amazon Web Services (AWS), Microsoft Azure, or Google Cloud Platform (GCP).

4. The method of claim 1, wherein identifying characteristics comprises estimating clock skew from inter-packet timing jitter observed in passively captured traffic and classifying transmission-behavior signatures based on packet size distributions, inter-arrival statistics, retransmission patterns, or TCP/IP stack nuances.

5. (canceled)

6. The method of claim 1, further comprising ingesting one or more device or network logs via SYSLOG and polling one or more network devices via Simple Network Management Protocol (SNMP) to enhance identification and profiling.

7. The method of claim 1, wherein creating the dynamic baseline profiles comprises maintaining device-type-specific baselines that differ for cameras, programmable logic controllers (PLCs), printers, or other device classes.

8. (canceled)

9. The method of claim 1, wherein applying the network-layer protections comprises assigning the anomalous device to a Layer-3 micro-segment configured to provide reachability only between the device and a designated gateway, with lateral traffic to other endpoints denied.

10. (canceled)

11. The method of claim 1, further comprising detecting anomalies in encrypted network traffic without decrypting packet contents by analyzing one or more of flow timing, length sequences, directionality, burst profiles, Server Name Indication (SNI) metadata, or endpoint reputation.

12. The method of claim 1, further comprising generating regulatory-posture outputs comprising audit logs and compliance reports indicative of isolation actions, segmentation changes, and anomaly detections.

13. A computer-implemented method for Zero Trust enforcement in a computer network, comprising:
continuously verifying authorization of one or more network devices based on device identity derived from hardware fingerprinting including clock-skew estimation and transmission-behavior signatures and based on dynamic per-device behavioral baselines;
computing, for each device, a risk score as a function of deviations from the behavioral baseline and one or more external threat-intelligence indicators; and
in response to the risk score satisfying one or more thresholds, programmatically updating network-layer policy in real time by adjusting one or more of DHCP assignments, VLAN memberships, and access-control lists to restrict or isolate the device.

14. The method of claim 13, wherein programmatically updating the network-layer policy comprises issuing instructions to an SDN controller and a DHCP server to enforce the policy changes without manual intervention.

15. The method of claim 13, wherein continuously verifying authorization includes re-evaluating authorization upon one or more of device posture changes, location changes, firmware updates, or detected anomalous flows.

16. A system for dynamically managing one or more network devices, comprising:
one or more processors; and
a memory storing instructions that, when executed by the one or more processors, cause the system to:
deploy an agent within a network to monitor network traffic and collect data from the one or more network devices;
perform passive network monitoring to analyze the network traffic without active scanning;
discover the one or more network devices based on data collected by the agent;
identify characteristics of the one or more network devices using hardware fingerprinting and protocol analysis, the identifying including analyzing MAC-layer attributes, clock-skew estimates, and transmission-behavior signatures;
create dynamic baseline profiles for the one or more network devices and continuously update the dynamic baseline profiles based on observed behavior;
detect anomalies by comparing current behavior to the dynamic baseline profiles; and
apply network-layer protections in response to the anomalies by dynamically adjusting network-segmentation policy and assigning one or more devices to DHCP-based micro-segmented subnets.

17. The system of claim 16, further comprising an encrypted-traffic analyzer configured to detect anomalies in encrypted traffic without decryption by evaluating flow-level timing, size, and directionality features.

18. The system of claim 16, wherein the agent is configured to ingest mirrored traffic via a SPAN or TAP interface.

19. The system of claim 16, wherein the system further comprises a SYSLOG receiver and an SNMP collector to obtain logs and management data from gateways, switches, or the one or more network devices.

20. The system of claim 16, wherein the network-layer protections comprise configuring a Layer-3 micro-segment for an anomalous device that provides reachability only between the device and a designated gateway and a set of explicitly permitted endpoints, with lateral traffic to other endpoints denied.

21. (canceled)

22. The system of claim 16, wherein the system performs user and entity behavior analytics (UEBA) to detect user-device anomalies.

23. The system of claim 16, wherein the system is configured to integrate with one or more asset-management systems to cross-reference discovered devices with existing inventories.

24. The system of claim 16, wherein dynamically adjusting the network-segmentation policy comprises issuing updates to an SDN controller to modify one or more access-control lists or VLAN assignments.

25-31. (canceled)
